(19) United States
(12) Patent Application Publication
(10) Pub. No.: US 2010/0276912 A1
(43) Pub. Date: Nov. 4, 2010

(54) SKATEBOARD LEASH

(76) Inventors: Nathaniel Joseph Lange, Indianapolis, IN (US); Sondra Sutton, Grand Junction, MI (US); Dan Edward Hogan, JR., Holland, MI (US)

Correspondence Address: GREER, BURNS & CRAIN, 300 S WACKER DR, 25TH FLOOR, CHICAGO, IL, 60606, US

(21) Appl. No.: 12/432,208

(22) Filed: Apr. 29, 2009

(51) Int. Cl. B60R 99/00

(52) U.S. Cl. 280/727

(57) ABSTRACT

A skateboard leash for attachment to a skateboard includes a harness strap assembly mounted transversely across the skateboard, and a leash assembly linked to the harness strap assembly at a lower portion of the leash assembly. The leash assembly also has a length adjusting strap at an upper portion of the leash assembly, and an elastic member. The elastic member is either linked to the length adjusting strap or incorporated into the length adjusting strap. Adjustment of the length of the leash assembly is made at the upper portion of the leash assembly.

### BACKGROUND

Embodiments described herein relate to accessories for skateboards. More particularly, embodiments described herein relate to a skateboard leash that is attachable to a skateboard.

Skateboarding frequently involves the performance of a multitude of maneuvers or tricks on a skateboard. Maintaining contact with the skateboard allows a skateboarder to exercise greater control over the skateboard to perform the maneuvers or tricks. However, the skateboarder may experience difficulty in maintaining contact with the skateboard, particularly in rough terrain, in inclement weather, or when aerial maneuvers are performed.

During aerial maneuvers, the skateboarder may desire that the skateboard be held against the skateboarder's feet to control the location of skateboard for landing. Maintaining the skateboard against the skateboarder's feet may be attained by manually holding the skateboard against the skateboarder's feet, which requires the skateboarder to bend over to grasp the skateboard. Grasping the skateboard while executing the maneuver or trick may be difficult for the skateboarder.

Skateboard leashes enable the skateboarder to remain in a generally upright position while retaining the skateboard near the skateboarder's feet, for example during aerial maneuvers. Skateboard leashes may be used for both training purposes for a less accomplished skateboarder, and for enhancing the aerial maneuver or trick of a more accomplished skateboarder.

Conventional skateboard leashes may require either a specific configuration of the skateboard, or a modification to the skateboard to attach the skateboard leash to the skateboard. For example, some skateboard leashes may require the skateboard to have a receiving structure, such as holes or connectors, in a deck of the skateboard. The skateboard leash is received by the receiving structure in the skateboard. When the skateboard leash is removed from the skateboard, the holes or other connectors may remain in the deck of the skateboard. For this reason, many conventional skateboard leashes may not be both readily attachable and fully detachable from the conventional skateboard having no receiving structure. Additionally, some conventional skateboard leashes loop transversely around the skateboard in a way that the leash can slide along the length of the skateboard.

Other conventional skateboard leashes may connect to the body of the skateboarder, such as with a waist belt. However, skateboarders may find attachment of the skateboard leash to the body to be restraint on free movement during skateboarding. Further, skateboarders may not want to undertake the additional step of removing the waist belt for detachment of the skateboard leash from the skateboarder's body.

### SUMMARY

A skateboard leash for attachment to a skateboard includes a harness strap assembly mounted transversely across the skateboard, and a leash assembly linked to the harness strap assembly at a lower portion of the leash assembly. The leash assembly also has a length adjusting strap at an upper portion of the leash assembly, and an elastic member. The elastic member is either linked to the length adjusting strap or incorporated into the length adjusting strap. Adjustment of the length of the leash assembly is made at the upper portion of the leash assembly.

### BRIEF DESCRIPTION OF THE DRAWINGS

FIG. 1 is a perspective view of a skateboard leash attached to a skateboard.

FIG. 2 is a bottom view of the skateboard with the skateboard leash attached to the skateboard.

FIG. 3 is a perspective view of a second embodiment of a skateboard leash attached to the skateboard.

FIG. 4 is a perspective view of a third embodiment of a skateboard leash attached to the skateboard.

FIG. 5 is a perspective view of a fourth embodiment of a skateboard leash attached to the skateboard.

FIG. 6 is a perspective view of a fifth embodiment of a skateboard leash attached to the skateboard.

FIG. 7 is a perspective view of a sixth embodiment of a skateboard leash attached to the skateboard.

FIG. 8 is a perspective view of a seventh embodiment of a skateboard leash attached to the skateboard.

### DETAILED DESCRIPTION

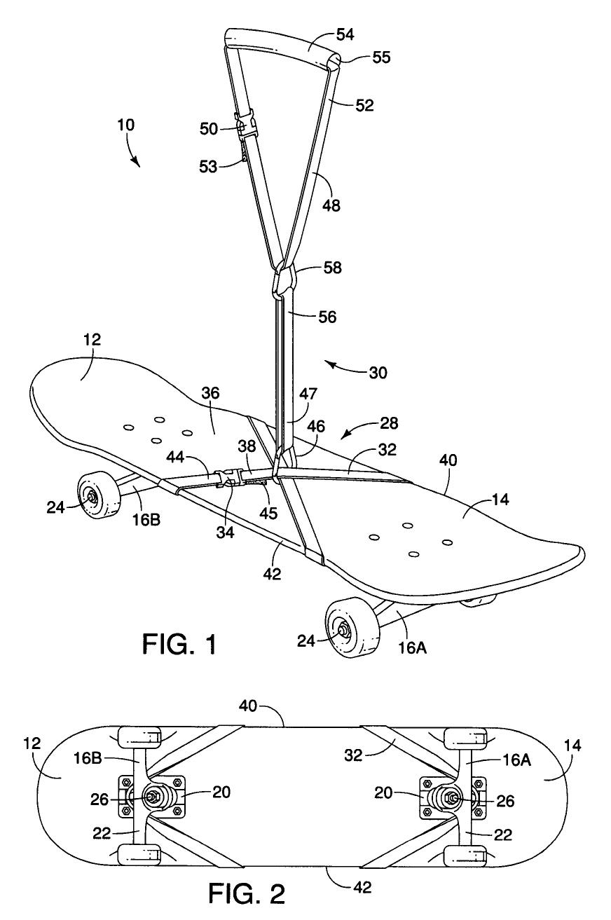

Referring to FIG. 1 and FIG. 2, a skateboard leash is depicted generally at 10 attached to a skateboard 12. The skateboard 12 has a generally elongate deck 14 which may be made of wood, fiberglass, bamboo, resin, Kevlar®, carbon fiber, aluminum, plastic, or any other materials. The deck 14 may be about 7 to 10.5 inches wide, and may be about 28 to 33 inches long, although any other dimensions are possible.

Attached to the deck 14 may be two metal trucks 16 that connect two sets of wheels 18A, 18B to the deck. The trucks 16 may have two parts, a baseplate 20 that is attached to the deck 14, and a hanger 22. An axle 24 runs through the hanger 22. Between the baseplate 20 and the hanger 22 are bushings (not shown) that enable the movement of the axle 24 relative to the baseplate 20 for turning of the skateboard. An adjustable kingpin bolt 26 fits inside the bushings.

The skateboard leash 10 includes a harness strap assembly indicated generally at 28 that is selectively attachable to the skateboard 12, and a leash assembly indicated generally at 30 which extends from the harness strap assembly. The harness strap assembly 28 is configured to be mounted generally transversely around the skateboard 12, and includes a harness strap 32 and a connector 34, such as a clip or buckle. The harness strap 32 may be nylon having a ¾-inch width and a 32-inch length, however other materials and dimensions are possible. The connector 34 may have interlocking components, and may be attached to the harness strap 32 such as by sewing, however other configurations are possible. The connector 34 may be a metal slide clip or buckle, however other connectors are possible.

The harness strap 32 may be wrapped around the skateboard 12 in a plurality of ways, however the harness strap 32 may be attached to the skateboard 12 in an X-configuration over a top surface 36 of the deck 14. The X-configuration of the harness strap 32 allows a front portion and a rear portion of the top surface 36 of the skateboard 12 to be generally unobstructed by the harness strap, which may allow both contact between the skateboarder and the board, and also may allow the skateboarder to perform certain maneuvers, such as “grinding”, without interference by the harness strap 32.

An exemplary method of wrapping the harness strap 32 around the skateboard 12 includes retaining a first end 38 of the harness strap on the top surface 36 of the deck 14, extending the harness strap to a first side 40 of the deck, wrapping the harness strap around an outer surface of the first truck 16A, extending the harness strap to a second side 42 and to the top surface 36, crossing the harness strap to form an X-configuration at the top surface 36, extending the harness strap to the first side 40 and around an outer surface of the second truck 16B, extending the harness strap back to the second side 42, and connecting a second end 44 and the first end 38 with the connector 34. The connector 34 may be adjustable such that the harness strap 32 can be pulled generally taut around the skateboard 12. The harness strap 32 may have a hook and loop fastener 45, such as VELCRO®, to attach any loose end back onto the harness strap. Any other configuration of harness strap 32 attachment onto the skateboard 12 is possible, however the X-configuration is a more stable configuration than a transverse loop around the skateboard 12.

The leash assembly 30 includes an attachment member 46 which is attached to the harness strap assembly 28, generally at the crossing of the harness strap 32 forming the X-configuration, to link the leash assembly 30 to the harness strap assembly 28. The leash assembly 30 may extend from the harness strap assembly 28 generally centrally on the skateboard 12, which may result in the skateboarder maintaining a generally centered position on the skateboard. A lower portion 47 of the skateboard leash 30 is attached to the attachment member 46 and to the harness strap assembly 28. As will be described below, at least a portion of the leash assembly 30 exhibits elastic material properties.

In the skateboard leash 10, the attachment member is a carabiner clip 46, however other attachment members such as clips, buckles, and connectors are possible. The attachment member 46 may be selectively openable and closeable to encircle the harness strap assembly 28. Advantageously, the attachment member 46 encircles both passes of the harness strap 32 generally at the location of their crossing, i.e. at the center of the X-configuration.

The leash assembly 30 includes a length adjusting strap 48 which may form a loop, however other configurations are possible. An adjustment member 50, such as a buckle or clip, lengthens and shortens the length adjusting strap 48, which in turn, lengthens and shortens the leash assembly 30 to accommodate different heights of skateboarders. The length adjusting strap 32 may be nylon having a ¾-inch width and a 13-inch length, however other materials and dimensions are possible. The adjustment member 50 may be attached to the length adjusting strap 48 such as by sewing, however other configurations and attachment methods are possible.

The skateboarder may adjust the length of the leash assembly 30 while in the standing position, or may even adjust the length while skateboarding, since the length adjusting strap 48 is at an upper portion 52 of the skateboard leash 10. The upper portion 52 of the leash assembly 30 is above or further away from the skateboard 12 than the lower portion 47. With length adjustment at the upper portion 52, the skateboarder does not have to crouch down by the skateboard to adjust the leash assembly 30. A hook and loop fastener 53, such as VELCRO®, may be disposed on the length adjusting strap 48 to attach any loose end back onto the length adjusting strap 48.

A handle 54 may be disposed on the length adjusting strap 48, and the length adjusting strap 48 may be slidingly received in a thru-passage 55 in the handle such that the handle can be relocated along the length adjusting strap, such as when the length of the strap is adjusted. The handle 54 may be made of rubber, however other materials are possible. The handle 54 may have a length sufficient for one or both hands of the skateboarder to engage the handle, however other lengths are possible.

The leash assembly 30 also includes an elastic member 56, which may be directly or indirectly attached to the length adjusting strap 48. In the skateboard leash 10, a link 58, such as a carabiners clip, attaches the elastic member 56 to the length adjusting strap 48, however other attachment members such as clips, buckles, and connectors are possible. The link 58 may be selectively openable and closeable to attach the elastic member 56 to the length adjusting strap 48.

The elastic member 56 is attached to the harness strap assembly 28, either directly or indirectly with the attachment member 46, and is attached to the length adjusting strap 48, either directly or indirectly with the link 58. The elastic member 56 may be a rubber strap, band or ring, however any other material or configuration that provides an elastic material behavior and that links the harness strap assembly 28 to the length adjusting strap 48 is possible. The elastic member 56 may be rubber band that has a length of about 9-inches, a width of about ¾-inch, and a depth of about 1/10-inch, however any other configurations and dimensions are possible.

The elastic member 56 and the length adjusting strap 48 may be made of generally flexible materials to allow the twisting of the leash assembly 30 during use of the skateboard leash 10. With the harness strap assembly 28 mounted on the skateboard 12, a skateboarder may use the skateboard in a normal manner with the skateboarder's feet contacting the top surface 36 of the deck 14. The skateboarder may stand on the harness strap 32, however the harness strap 32 may be of sufficiently thin material that the skateboarder may not notice the harness strap beneath the skateboarder's feet.

When the skateboarder is performing a maneuver, the skateboarder grasps or pulls up on the handle 54 (or the length adjusting strap 48) which maintains the top surface 36 of the skateboard 12 against the feet of the skateboarder. The extension of the elastic member 56 allows the skateboarder to grasp the leash assembly 30 at varying heights while maintaining the skateboard 12 between the skateboarder's feet. In this configuration, the skateboard leash 10, through tension developed in the leash assembly 30 (including the length adjusting strap 48 and the elastic member 56), pulls the skateboard 12 towards the skateboarder. It should be appreciated that the tension developed in the leash assembly 30, which elongates the elastic member 56 and pulls the skateboard 12 towards the skateboarder, is applicable to all the embodiments discussed below.

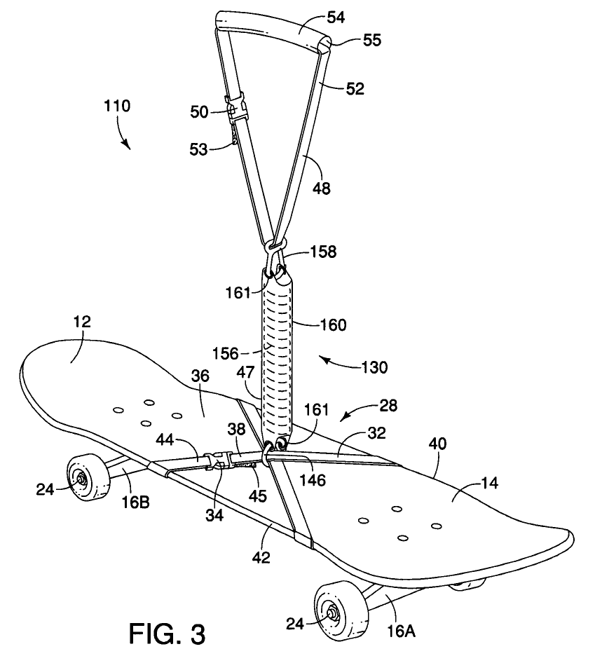

Referring now to FIG. 3, a second embodiment of skateboard leash is generally designated 110. Similar components with the skateboard leash 10 are designated with similar reference numbers in the 100-series.

The skateboard leash 110 includes the harness strap assembly 28 including the harness strap 32 and the connector 34. The harness strap assembly 28 forms a general X-configuration on the skateboard 12. An attachment member 146 of a leash assembly 130 attaches an elastic member 156 to the harness strap assembly 28. In the skateboard leash 110, the attachment member 146 is a ring, although other attachment members are possible.

The elastic member 156 may be a mechanical spring, which may or may not be enclosed in a cover 160. At the opposite end of the elastic member 156 is a link 158, which may be an I-hook or other mechanical link. The link 158 may selectively link the elastic member 156 to the length adjusting strap 48.

The cover 160 is generally tubular in shape and at least partially encloses the elastic member 156. The cover 160 has a length that exceeds the length of the elastic member 156 in the unstretched position, and a width that exceeds the width of the elastic member in the unstretched position. In this configuration, the elastic member 156 can freely extend/stretch and retract/unstretch within the cover 160. Grommets 161 may be provided on the ends of the cover 160 that can be attached to the link 158 and the attachment member 146 so that the cover may extend and retract/bunch up with the retraction of the elastic member 156. The grommets 161 may help prevent ripping and tearing of the cover 160. It should be appreciated that besides the mechanical spring 156, the cover 160 may also enclose any other elastic member 156, such as a rubber band 56 (as seen in FIG. 1). The cover 160 protects the elastic member 156, such as from weathering. Further, the length of the cover 160 may provide an upper limit that the elastic member 156 can extend. The cover 160 may be formed of nylon/polypropylene, however other materials are contemplated.

The elastic member 156 elongates when the leash assembly 130 is under tension from the skateboarder. The tension in the leash assembly 130 forces the skateboard 12 towards the skateboarder to maintain contact between the skateboarders feet and the deck of the skateboard 12.

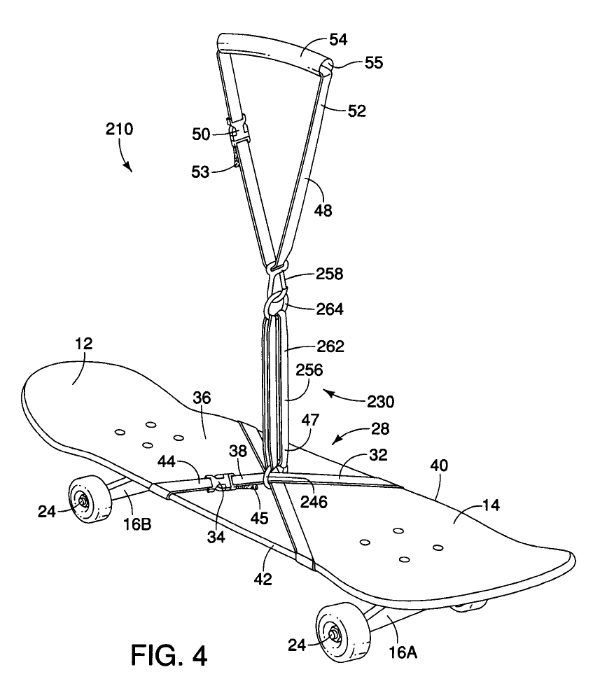

Referring now to FIG. 4, a third embodiment of skateboard leash is generally designated 210. Similar components with the skateboard leash 10 are designated with similar reference numbers in the 200-series.

The skateboard leash 210 includes the harness strap assembly 28 including the harness strap 32 and the connector 34. The harness strap assembly 28 forms a general X-configuration on the skateboard 12. An attachment member 246 of a leash assembly 230 attaches an elastic member 256 to the harness strap assembly 28. In the skateboard leash 210, the attachment member 246 is a ring, although other attachment members are possible.

The elastic member 256 is a rubber member 262 that extends between the attachment member 246 and a second link 264, which may also be a ring. A first link 258, which may be an I-hook or other mechanical link, may selectively attach the elastic member 256 to the second link 264 and to the length adjusting strap 48. The link 258 may allow rotation, for example 360-degrees, to prevent entanglement of the leash assembly 230. Additionally, it is possible that the second link 264 may be omitted such that the rubber member 262 is directly linked to the first link 258, or alternatively, it is possible that the first link 258 may be omitted such that second link 264 of the elastic member 256 is directly attached to the length adjusting strap 48 of the leash assembly 30. The elastic member 256 elongates when the leash assembly 230 is under tension from the skateboarder.

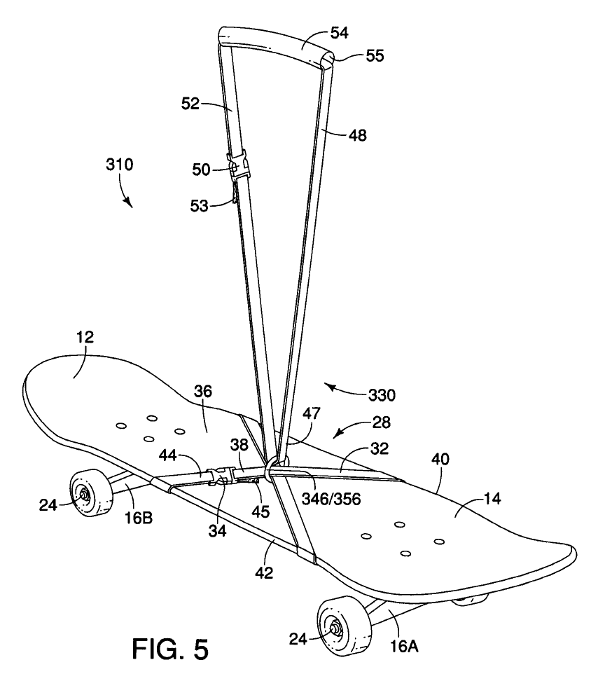

Referring now to FIG. 5, a fourth embodiment of skateboard leash is generally designated 310. Similar components with the skateboard leash 10 are designated with similar reference numbers in the 300-series.

The skateboard leash 310 includes the harness strap assembly 28 including the harness strap 32 and the connector 34. The harness strap assembly 28 forms a general X-configuration on the skateboard 12. An attachment member 346 of the leash assembly 330 is also an elastic member 356, and links the harness strap assembly 28 to the length adjusting strap 48.

In the skateboard leash 310, the combined attachment member 346/elastic member 356 is an elastic ring, such as a high elasticity rubber ring, however other materials and configurations are possible. The length adjusting strap 48 of the leash assembly 330 is linked to the combined attachment member 346/elastic member 356, which is in turn linked to the harness strap assembly 28. The combination attachment member 346/elastic member 356 elongates when the leash assembly 330 is under tension from the skateboarder. It is possible that the length adjusting strap 48 may also made of a material exhibiting elastic properties.

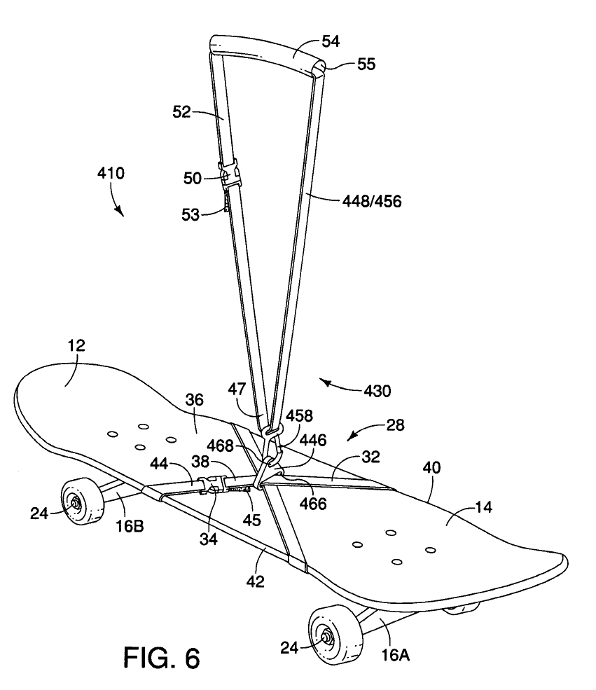

Referring now to FIG. 6, a fifth embodiment of skateboard leash is generally designated 410. Similar components with the skateboard leash 10 are designated with similar reference numbers in the 400-series.

The skateboard leash 410 includes the harness strap assembly 28 including the harness strap 32 and the connector 34. The harness strap assembly 28 forms a general X-configuration on the skateboard 12. An attachment member 446 of a leash assembly 430 is linked to the harness strap assembly 28, and may be a triangular shaped member with a first receiving hole 466 for receiving the harness strap 32 and a second receiving hole 468 for receiving a link 458, however other shapes and configurations of attachment member 446 are possible. The link 458 may be a selectively openable hook, however other links are possible.

An elastic member 456 is incorporated into the length adjusting strap 448. A combination length adjusting strap 448/elastic member 456 forms a loop and may have an adjustment member 450 for adjusting the length of the combination length adjusting strap 448/elastic member 456. The combination length adjusting strap 448/elastic member 456 may be formed of rubber or any other elastic material. The combination length adjusting strap 448/elastic member 456 elongates when the leash assembly 430 is under tension from the skateboarder.

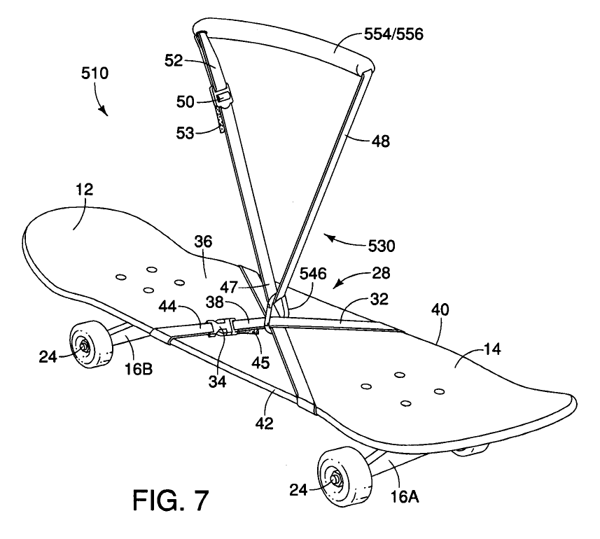

Referring now to FIG. 7, a sixth embodiment of skateboard leash is generally designated 510. Similar components with the skateboard leash 10 are designated with similar reference numbers in the 500-series.

The skateboard leash 510 includes the harness strap assembly 28 including the harness strap 32 and the connector 34. The harness strap assembly 28 forms a general X-configuration on the skateboard 12. An attachment member 546 of a leash assembly 530 is linked to the harness strap assembly 28, and may be a carabiner clip or any other linking member. The length adjusting strap 48 may be fixed to one end of a handle 554, and the length adjusting strap may be doubled-back thru the handle 554 to the adjustment member 50. It is possible that the length adjusting strap may be formed of a material that is either elastic or non-elastic.

The handle 554 may be rubber or some other elastic material such that the handle is the elastic member 556. In this configuration, the elastic member is incorporated into the handle 554 or the length adjusting strap 48. The combination handle 554/elastic member 556 elongates when the leash assembly 530 is under tension from the skateboarder.

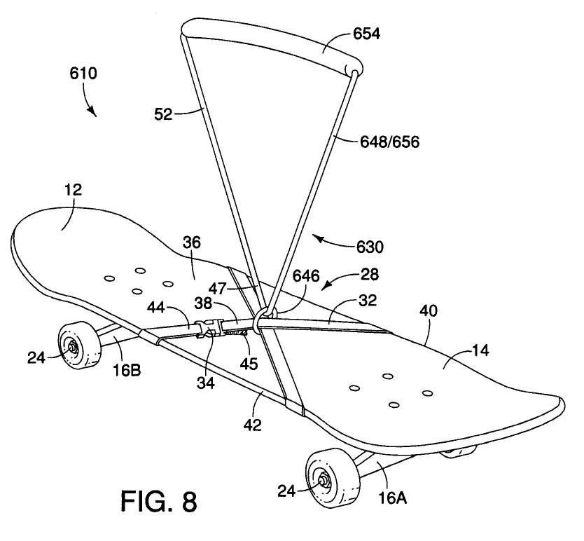

Referring now to FIG. 8, a seventh embodiment of skateboard leash is generally designated 610. Similar components with the skateboard leash 10 are designated with similar reference numbers in the 600-series.

The skateboard leash 610 includes the harness strap assembly 28 including the harness strap 32 and the connector 34. The harness strap assembly 28 forms a general X-configuration on the skateboard 12. An attachment member 646 of the leash assembly 630 is linked to the harness strap assembly 28, and may be a ring or any linking member.

Extending from the attachment member 646 is a combination length adjusting strap 648/elastic member 656 which may be formed of rubber or any other elastic material. The length adjusting strap 648 incorporates the elastic member 656. Further, the handle 654 may also be formed of rubber or any other elastic material. Together, the combination length adjusting strap 648/elastic member 656 and the handle 654 may elongate when the leash assembly 630 is under tension. Additionally, the attachment member 646 may be formed of an elastic material.

It should be appreciated that the length adjustment of the length adjusting strap 48, 448, 648 may be provided with an adjustment member 50 or may be provided by the elasticity of the strap itself.

The skateboard leash 10-610 is contemplated to be used as a training tool for beginners, as a tool for enhancing maneuvers or tricks for more experienced skateboarders, and as a tool for increased stability and control, among other uses. Further, the skateboard leash 10-610 can be used with a conventional skateboard 12 in an unobtrusive way, without the need to place mounting hardware or holes in the skateboard for receiving the skateboard leash. Additionally, the skateboard leash 10-610 is not positively secured around the skateboarder so that the skateboarder can easily sever themselves from the skateboard leash. The skateboard leash 10-610 is fully adjustable to fit any size skateboard and any size skateboarder. The skateboarder can adjust the length of the leash assembly 30 standing up or even while skateboarding since the length adjusting strap is at an upper distal end 52 of the skateboard leash 10-610. Further, since the length adjusting strap 48 is relatively longer than the elastic member 50, a large range of leash assembly 30 adjustment is provided. Further still, the skateboard leash 10-610 can be used to carry the skateboard.

The present skateboard leash may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A skateboard leash for attachment to a skateboard, the skateboard leash comprising:
a harness strap assembly mounted transversely across the skateboard;
a leash assembly linked to the harness strap assembly at a lower portion of the leash assembly, and having an upper portion opposite the lower portion, wherein the leash assembly comprises:
a length adjusting strap at the upper portion of the leash assembly;
an elastic member one of linked to the length adjusting strap and incorporated into the length adjusting strap;
wherein length adjustment of the leash assembly is made at the upper portion of the leash assembly.

2. The skateboard leash of claim 1 wherein the leash assembly further comprises an attachment member linking the harness strap assembly to the leash assembly.

3. The skateboard leash of claim 1 wherein the harness strap assembly further comprises a harness strap and a connector disposed on the harness strap for adjustably connecting the harness strap to the skateboard.

4. The skateboard leash of claim 1 wherein the length adjusting strap further comprises an adjustment member for adjusting the length of the length adjusting strap.

5. The skateboard leash of claim 1 wherein the length adjusting strap is formed of a non-elastic material.

6. The skateboard leash of claim 1 wherein the length adjusting strap is formed of an elastic material.

7. The skateboard leash of claim 1 wherein the harness strap assembly has an X-configuration around the skateboard.

8. The skateboard leash of claim 1 wherein the elastic member is a spring.

9. The skateboard leash of claim 1 wherein the elastic member is a handle formed of an elastic material.

10. The skateboard leash of claim 1 wherein the elastic member is the length adjusting strap formed of an elastic material.

11. The skateboard leash of claim 2 wherein the elastic member is the attachment member.

12. The skateboard leash of claim 1 further comprising a cover at least partially enclosing the elastic member.

13. A skateboard leash for attachment to a skateboard, the skateboard leash comprising:
a harness strap assembly mounted transversely across the skateboard;
a leash assembly linked to the harness strap assembly at a lower portion of the leash assembly, and having an upper portion opposite the lower portion, wherein the leash assembly comprises:
a length adjusting strap at the upper portion of the leash assembly;
an elastic member disposed between the harness strap assembly and the length adjusting strap;
wherein length adjustment of the leash assembly is made at the upper portion of the leash assembly.

14. The skateboard leash of claim 13 further comprising an attachment member linking the elastic member to the harness strap assembly.

15. The skateboard leash of claim 13 further comprising an attachment member, wherein the elastic member is the attachment member.

16. The skateboard leash of claim 13 wherein the elastic member is a spring.

17. A skateboard leash for attachment to a skateboard, the skateboard leash comprising:
a harness strap assembly mounted transversely across the skateboard;
a leash assembly linked to the harness strap assembly at a lower portion of the leash assembly, and having an upper portion opposite the lower portion, wherein the leash assembly includes a length adjusting strap at the upper portion of the leash assembly, wherein the length adjusting strap includes an elastic member;
wherein length adjustment of the leash assembly is made at the upper portion of the leash assembly.

18. The skateboard leash of claim 17 wherein the elastic member is a handle disposed on the length adjusting strap, and the handle is formed of an elastic material.

19. The skateboard leash of claim 17 wherein the elastic member is the length adjusting strap formed of an elastic material.

20. The skateboard leash of claim 17 wherein the harness strap assembly includes a harness strap that is mounted around the skateboard in an X-configuration.
